(19) United States
(12) Patent Application Publication
(10) Pub. No.: US 2026/0164369 A1
(43) Pub. Date: Jun. 11, 2026

(54) RELAY NODE AIDED MULTIPLE-USER MULTIPLE-INPUT MULTIPLE-OUTPUT COMMUNICATION

(71) Applicant: QUALCOMM Incorporated, San Diego, CA (US)

(72) Inventors: Ahmed ELSHAFIE, San Diego, CA (US); Yu ZHANG, San Diego, CA (US); Hung Dinh LY, San Diego, CA (US); Seyedkianoush HOSSEINI, San Diego, CA (US)

(21) Appl. No.: 18/708,549

(22) PCT Filed: Dec. 7, 2021
(86) PCT No.: PCT/CN2021/136116

§ 371 Date: May 8, 2024

(51) Int. Cl. H04W 52/36; H04B 7/0452

(52) U.S. Cl. CPC H04W 52/367; H04B 7/0452

(57) ABSTRACT

Various aspects of the present disclosure generally relate to wireless communication. In some aspects, a relay node may receive information associated with identifying a configured power level of a communication at a receive node. The relay node may relay the communication from a transmit node to the receive node in accordance with the configured power level, wherein relaying the communication includes attenuating or amplifying the communication based at least in part on the configured power level. Numerous other aspects are described.

### FIELD OF THE DISCLOSURE

Aspects of the present disclosure generally relate to wireless communication and to techniques and apparatuses for relay node aided multiple-user multiple-input multiple-output (MU-MIMO) communication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a relay node. The method may include receiving information associated with identifying a configured power level of a communication at a receive node. The method may include relaying the communication from a transmit node to the receive node in accordance with the configured power level, wherein relaying the communication includes attenuating or amplifying the communication based at least in part on the configured power level.

Some aspects described herein relate to a method of wireless communication performed by a receive node. The method may include transmitting, to a relay node associated with relaying communications for a first transmit node, information associated with identifying a configured power level at a receive node, wherein the configured power level is based at least in part on a first configuration of the first transmit node and a second configuration of a second transmit node in communication with the receive node. The method may include receiving one or more communications from at least one of the first transmit node, via the relay node, or the second transmit node in accordance with the configured power level, wherein the relay node is configured for attenuating or amplifying a communication, of the one or more communications, based at least in part on the configured power level.

Some aspects described herein relate to a method of wireless communication performed by a transmit node. The method may include receiving, from a relay node, information associated with identifying a configured power level of a communication at a receive node. The method may include transmitting the communication to the receive node in accordance with the configured power level and via a relay node, wherein the communication is attenuated or amplified based at least in part on the configured power level.

Some aspects described herein relate to a relay node for wireless communication. The relay node may include a memory and one or more processors coupled to the memory. The one or more processors may be configured to receive information associated with identifying a configured power level of a communication at a receive node. The one or more processors may be configured to relay the communication from a transmit node to the receive node in accordance with the configured power level, wherein relaying the communication includes attenuating or amplifying the communication based at least in part on the configured power level.

Some aspects described herein relate to a receive node for wireless communication. The receive node may include a memory and one or more processors coupled to the memory. The one or more processors may be configured to transmit, to a relay node associated with relaying communications for a first transmit node, information associated with identifying a configured power level at a receive node, wherein the configured power level is based at least in part on a first configuration of the first transmit node and a second configuration of a second transmit node in communication with the receive node. The one or more processors may be configured to receive one or more communications from at least one of the first transmit node, via the relay node, or the second transmit node in accordance with the configured power level, wherein the relay node is configured for attenuating or amplifying a communication, of the one or more communications, based at least in part on the configured power level.

Some aspects described herein relate to a transmit node for wireless communication. The transmit node may include a memory and one or more processors coupled to the memory. The one or more processors may be configured to receive, from a relay node, information associated with identifying a configured power level of a communication at a receive node. The one or more processors may be configured to transmit the communication to the receive node in accordance with the configured power level and via a relay node, wherein the communication is attenuated or amplified based at least in part on the configured power level.

Some aspects described herein relate to a non-transitory computer-readable medium that stores a set of instructions for wireless communication by a relay node. The set of instructions, when executed by one or more processors of the relay node, may cause the relay node to receive information associated with identifying a configured power level of a communication at a receive node. The set of instructions, when executed by one or more processors of the relay node, may cause the relay node to relay the communication from a transmit node to the receive node in accordance with the configured power level, wherein relaying the communication includes attenuating or amplifying the communication based at least in part on the configured power level.

Some aspects described herein relate to a non-transitory computer-readable medium that stores a set of instructions for wireless communication by a receive node. The set of instructions, when executed by one or more processors of the receive node, may cause the receive node to transmit, to a relay node associated with relaying communications for a first transmit node, information associated with identifying a configured power level at a receive node, wherein the configured power level is based at least in part on a first configuration of the first transmit node and a second configuration of a second transmit node in communication with the receive node. The set of instructions, when executed by one or more processors of the receive node, may cause the receive node to receive one or more communications from at least one of the first transmit node, via the relay node, or the second transmit node in accordance with the configured power level, wherein the relay node is configured for attenuating or amplifying a communication, of the one or more communications, based at least in part on the configured power level.

Some aspects described herein relate to a non-transitory computer-readable medium that stores a set of instructions for wireless communication by a transmit node. The set of instructions, when executed by one or more processors of the transmit node, may cause the transmit node to receive, from a relay node, information associated with identifying a configured power level of a communication at a receive node. The set of instructions, when executed by one or more processors of the transmit node, may cause the transmit node to transmit the communication to the receive node in accordance with the configured power level and via a relay node, wherein the communication is attenuated or amplified based at least in part on the configured power level.

Some aspects described herein relate to an apparatus for wireless communication. The apparatus may include means for receiving information associated with identifying a configured power level of a communication at a receive node. The apparatus may include means for relaying the communication from a transmit node to the receive node in accordance with the configured power level, wherein relaying the communication includes attenuating or amplifying the communication based at least in part on the configured power level.

Some aspects described herein relate to an apparatus for wireless communication. The apparatus may include means for transmitting, to a relay node associated with relaying communications for a first transmit node, information associated with identifying a configured power level at a receive node, wherein the configured power level is based at least in part on a first configuration of the first transmit node and a second configuration of a second transmit node in communication with the receive node. The apparatus may include means for receiving one or more communications from at least one of the first transmit node, via the relay node, or the second transmit node in accordance with the configured power level, wherein the relay node is configured for attenuating or amplifying a communication, of the one or more communications, based at least in part on the configured power level.

Some aspects described herein relate to an apparatus for wireless communication. The apparatus may include means for receiving, from a relay node, information associated with identifying a configured power level of a communication at a receive node. The apparatus may include means for transmitting the communication to the receive node in accordance with the configured power level and via a relay node, wherein the communication is attenuated or amplified based at least in part on the configured power level.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of coordination signaling, in accordance with the present disclosure.

FIG. 6 is a diagram illustrating an example of relay device that relays communications between a first UE and a second UE, in accordance with the present disclosure.

FIGS. 7A-7B are diagrams illustrating examples associated with relay node aided multiple-user multiple-input, multiple-output (MU-MIMO) communication, in accordance with the present disclosure.

FIGS. 8-10 are diagrams illustrating example processes associated with relay node aided MU-MIMO communication, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

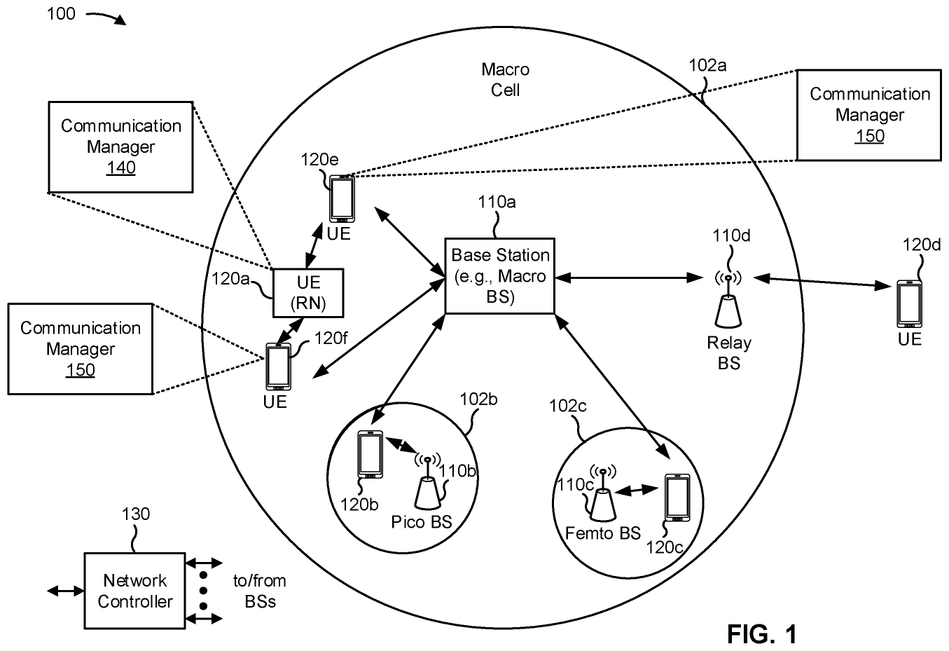

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, a UE 120e, and a UE 120f), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a, UE 120e, and UE 120f) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110. In some examples, a UE 120 may be a relay node for other UEs 120. For example, as shown, UE 120a may relay communications between UE 120e and UE 120f. In this case, UE 120a may be a relay node or reflecting node (RN) for UEs 120e and 120f.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR 1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the relay node may include a communication manager 140. As described in more detail elsewhere herein, the communication manager 140 may receive information associated with identifying a configured power level of a communication at a receive node; and relay the communication from a transmit node to the receive node in accordance with the configured power level, wherein relaying the communication includes attenuating or amplifying the communication based at least in part on the configured power level. Additionally, or alternatively, the communication manager 140 may perform one or more other operations described herein.

In some aspects, the receive node may include a communication manager 150. As described in more detail elsewhere herein, the communication manager 150 may transmit, to a relay node associated with relaying communications for a first transmit node, information associated with identifying a configured power level at a receive node, wherein the configured power level is based at least in part on a first configuration of the first transmit node and a second configuration of a second transmit node in communication with the receive node; and receive one or more communications from at least one of the first transmit node, via the relay node, or the second transmit node in accordance with the configured power level, wherein the relay node is configured for attenuating or amplifying a communication, of the one or more communications, based at least in part on the configured power level. Additionally, or alternatively, the communication manager 150 may perform one or more other operations described herein.

In some aspects, the transmit node may include a communication manager 150. As described in more detail elsewhere herein, the communication manager 150 may receive, from a relay node, information associated with identifying a configured power level of a communication at a receive node; and transmit the communication to the receive node in accordance with the configured power level and via a relay node, wherein the communication is attenuated or amplified based at least in part on the configured power level. Additionally, or alternatively, the communication manager 150 may perform one or more other operations described herein.

As indicated above, FIG. 1 is provided as an example. Other examples may differ from what is described with regard to FIG. 1.

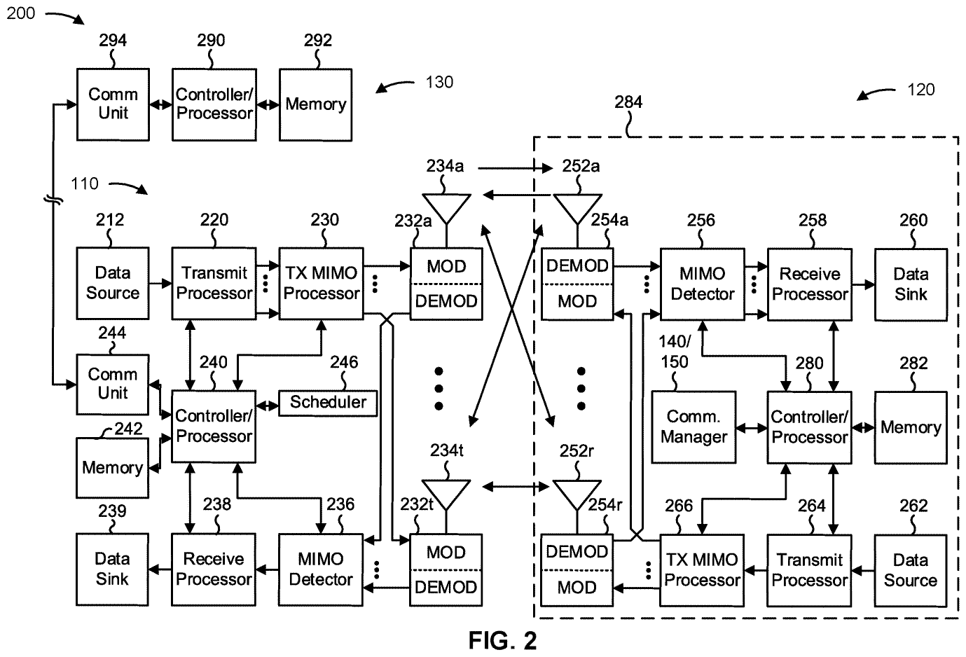

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

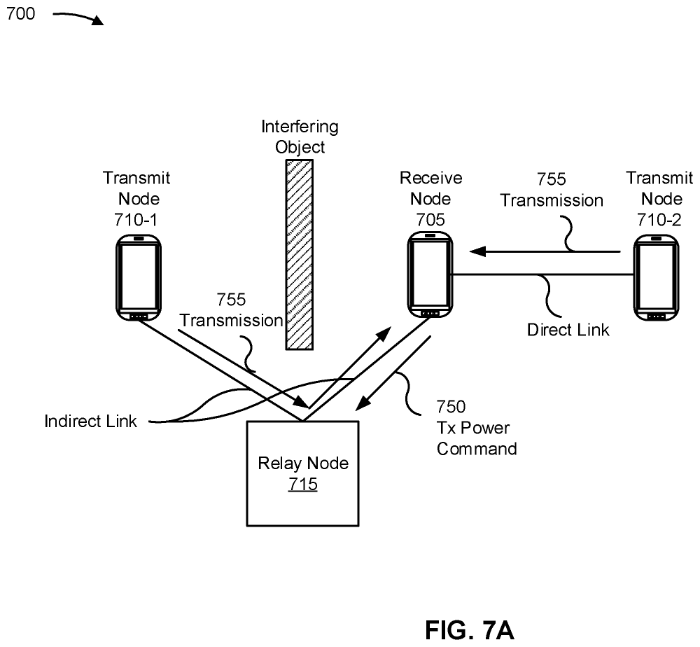

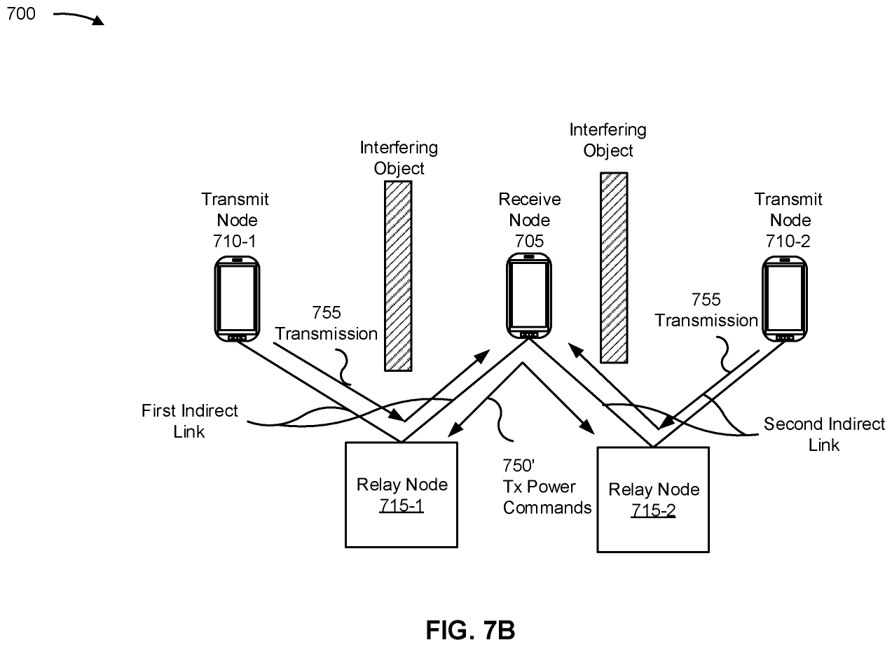

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-12).

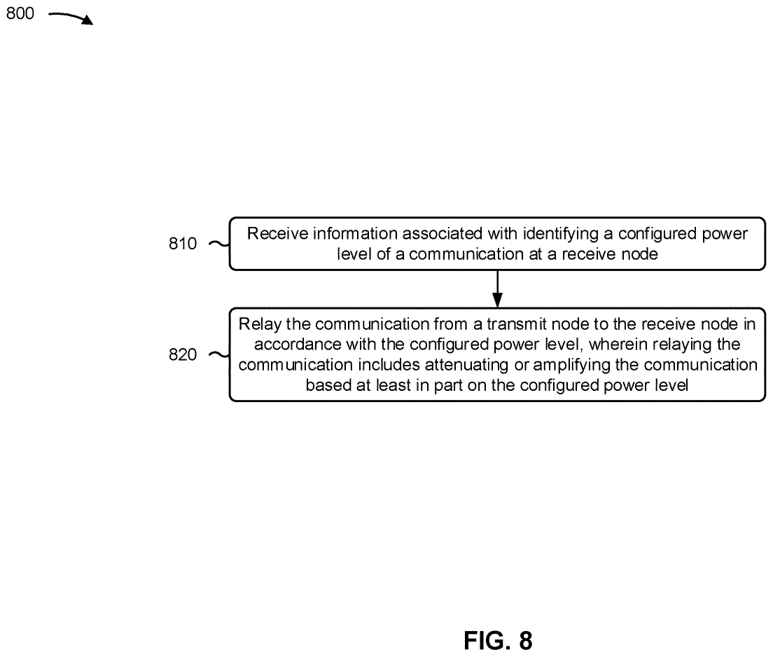

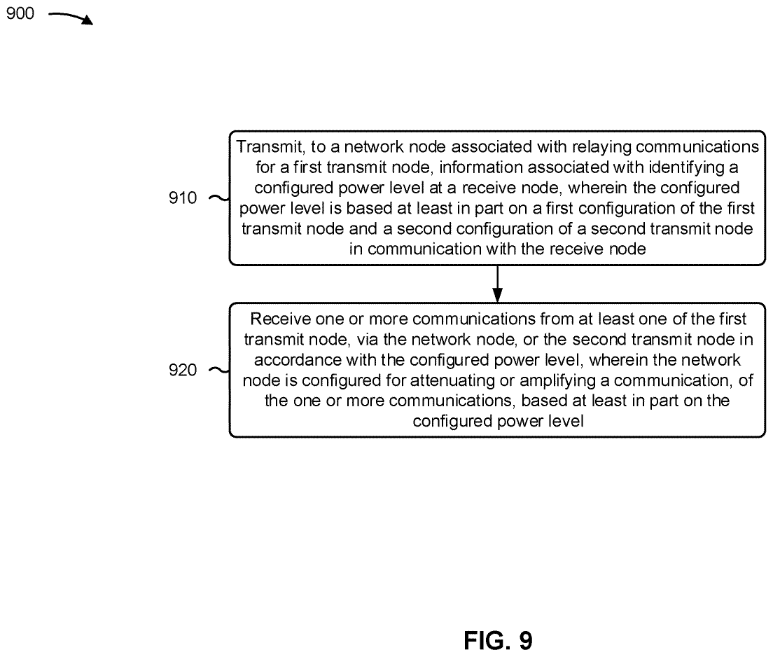

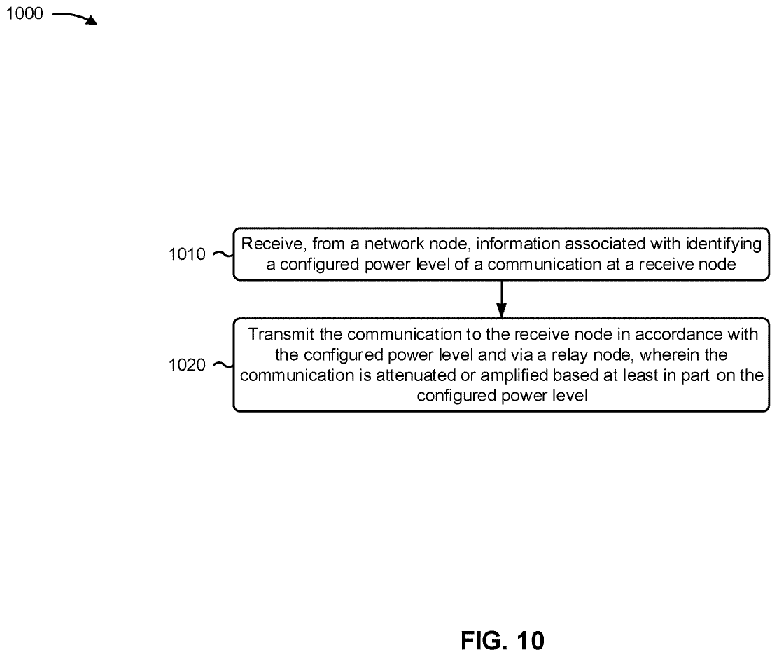

The controller/processor 240 of the base station 110, the controller/processor 280 of the UE 120, and/or any other component(s) of FIG. 2 may perform one or more techniques associated with relay node aided multiple-user multiple-input multiple-output (MU-MIMO) communication, as described in more detail elsewhere herein. In some aspects, the transmit node, network node, receive node, or relay node described herein is included in the UE 120 or includes one or more components of the UE 120. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a relay node (e.g., a UE 120) includes means for receiving (e.g., using antenna 252, modem 254, MIMO detector 256, receive processor 258, controller/processor 280, memory 282, or the like) information associated with identifying a configured power level of a communication at a receive node; and/or means for relaying (e.g., using controller/processor 280, transmit processor 264, TX MIMO processor 266, modem 254, antenna 252, memory 282, or the like) the communication from a transmit node to the receive node in accordance with the configured power level, wherein relaying the communication includes attenuating or amplifying the communication based at least in part on the configured power level. In some aspects, the means for the relay node to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the receive node includes means for transmitting (e.g., using controller/processor 280, transmit processor 264, TX MIMO processor 266, modem 254, antenna 252, memory 282, or the like), to a relay node associated with relaying communications for a first transmit node, information associated with identifying a configured power level at a receive node, wherein the configured power level is based at least in part on a first configuration of the first transmit node and a second configuration of a second transmit node in communication with the receive node; and/or means for receiving (e.g., using antenna 252, modem 254, MIMO detector 256, receive processor 258, controller/processor 280, memory 282, or the like) one or more communications from at least one of the first transmit node, via the relay node, or the second transmit node in accordance with the configured power level, wherein the relay node is configured for attenuating or amplifying a communication, of the one or more communications, based at least in part on the configured power level. In some aspects, the means for the receive node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the transmit node includes means for receiving (e.g., using antenna 252, modem 254, MIMO detector 256, receive processor 258, controller/processor 280, memory 282, or the like), from a relay node, information associated with identifying a configured power level of a communication at a receive node; and/or means for transmitting (e.g., using controller/processor 280, transmit processor 264, TX MIMO processor 266, modem 254, antenna 252, memory 282, or the like) the communication to the receive node in accordance with the configured power level and via a relay node, wherein the communication is attenuated or amplified based at least in part on the configured power level. In some aspects, the means for the transmit node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

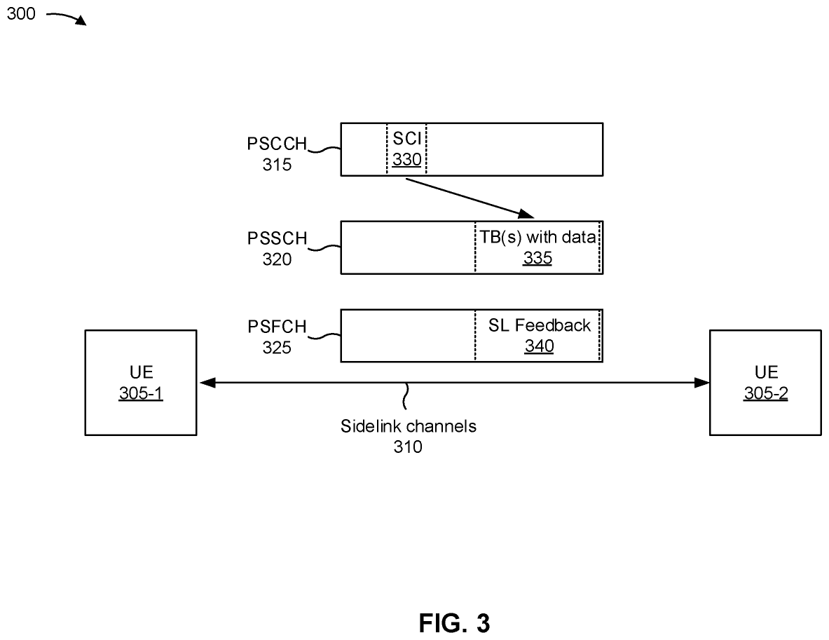

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. The UEs 305 (e.g., UE 305-1 and/or UE 305-2) may correspond to one or more other UEs described elsewhere herein, such as UE 120. In some cases, the UEs 305 may be network nodes (e.g., a transmit node and a receive node) that may communicate via a reflecting or relay node (e.g., a reconfigurable intelligent surface (RIS) or an amplify-and-forward (AF) relay). For ease of explanation, the reflecting or relay node will be referred to herein simply as a “relay node,” and it is understood that the term relay node is intended to refer to both relays and reflectors (such as an RIS). The one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

The one or more sidelink channels 310 may use resource pools. For example, a scheduling assignment (e.g., included in SCI 330) may be transmitted in sub-channels using specific resource blocks (RBs) across time. Data transmissions (e.g., on the PSSCH 320) associated with a scheduling assignment may occupy adjacent RBs in the same subframe as the scheduling assignment (e.g., using frequency division multiplexing). A scheduling assignment and associated data transmissions are not transmitted on adjacent RBs.

A UE 305 may operate using a sidelink transmission mode (e.g., Mode 1) where resource selection and/or scheduling is performed by a base station 110. For example, the UE 305 may receive a grant (e.g., in downlink control information (DCI) or in a radio resource control (RRC) message, such as for configured grants) from the base station 110 for sidelink channel access and/or scheduling. A UE 305 may operate using a transmission mode (e.g., Mode 2) where resource selection and/or scheduling is performed by the UE 305 (e.g., rather than a base station 110). The UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. A UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

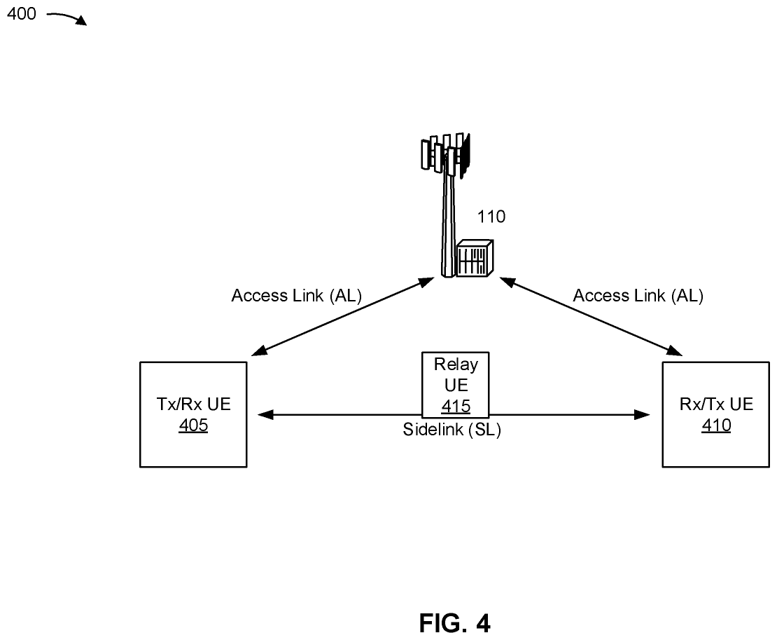

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink and a relay UE 415, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a link between UEs 120 (e.g., via a PC5 interface) without using base station 110 as a hop on the link (but which may use relay UE 415 as a hop on the link) may be referred to as a sidelink. A direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

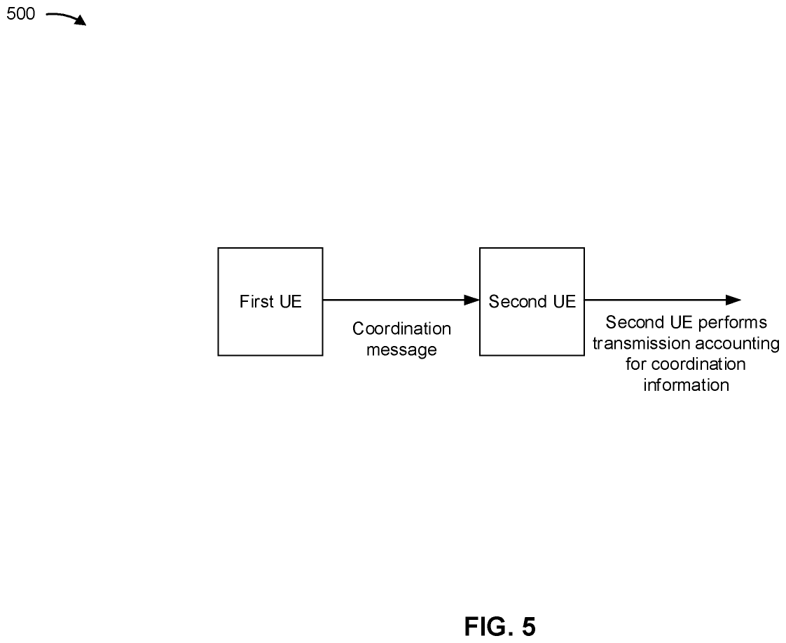

FIG. 5 is a diagram illustrating an example 500 of coordination signaling, in accordance with the present disclosure.

In example 500, a first UE (e.g., UE 120a of FIG. 1) exchanges inter-UE coordination signaling with a second UE (e.g., UE 120e or UE 120f of FIG. 1). The first UE and the second UE may operate in an in-coverage mode, a partial coverage mode, or an out-of-coverage mode with a base station 110. The first UE may determine a set of sidelink resources available for a resource allocation. The first UE may determine the set of sidelink resources based at least in part on determining that the set of sidelink resources are to be selected or based at least in part on a request, referred to herein as an inter-UE coordination request, received from the second UE or a base station 110. The first UE may determine the set of sidelink resources based at least in part on a sensing operation, which may be performed before receiving an inter-UE coordination request or after receiving the inter-UE coordination request.

The first UE may transmit an indication of the set of available resources to the second UE via inter-UE coordination signaling (shown as a coordination message, and referred to as “an inter-UE coordination message” or “inter-UE coordination information”). The first UE may transmit the indication of the set of available resources while operating in NR sidelink resource allocation mode 2. In NR sidelink resource allocation mode 2, resource allocation is handled by UEs (e.g., in comparison to NR sidelink resource allocation mode 1, in which resource allocation is handled by a scheduling entity, such as a base station 110). The indication of the set of available resources may identify resources that are preferred by the first UE for transmissions by the second UE. Alternatively, the indication of the set of available resources may identify resources that are not preferred by the first UE for transmissions by the second UE (e.g., with the available resources being those other than the resources that are not preferred). Additionally, or alternatively, the inter-UE coordination signaling may indicate a resource conflict (e.g., a collision), such as when two UEs have reserved the same resource (e.g., and were unable to detect this conflict because the two UEs transmitted a resource reservation message on the same resource and thus did not receive one another's resource reservation messages due to a half duplex constraint).

The second UE may select a sidelink resource for a transmission from the second UE based at least in part on the set of available resources indicated by the first UE. As shown, the second UE may account for the coordination information when transmitting (e.g., via a sidelink resource indicated as available by the inter-UE coordination message). Inter-UE coordination signaling related to resource allocation may reduce collisions between the first UE and the second UE and may reduce a power consumption for the first UE and/or the second UE (e.g., due to fewer retransmissions as a result of fewer collisions).

Although FIG. 5 shows a single first UE transmitting inter-UE coordination information to a single second UE, a single first UE may transmit inter-UE coordination information to multiple UEs to assist those UEs with selecting resources for transmissions. Additionally, or alternatively, the second UE may receive inter-UE coordination information from multiple UEs and may use that information to select resources for a transmission (e.g., resources that avoid a conflict with all of the multiple UEs or as many as possible).

As indicated above, FIG. 5 is provided as an example. Other examples may differ from what is described with respect to FIG. 5.

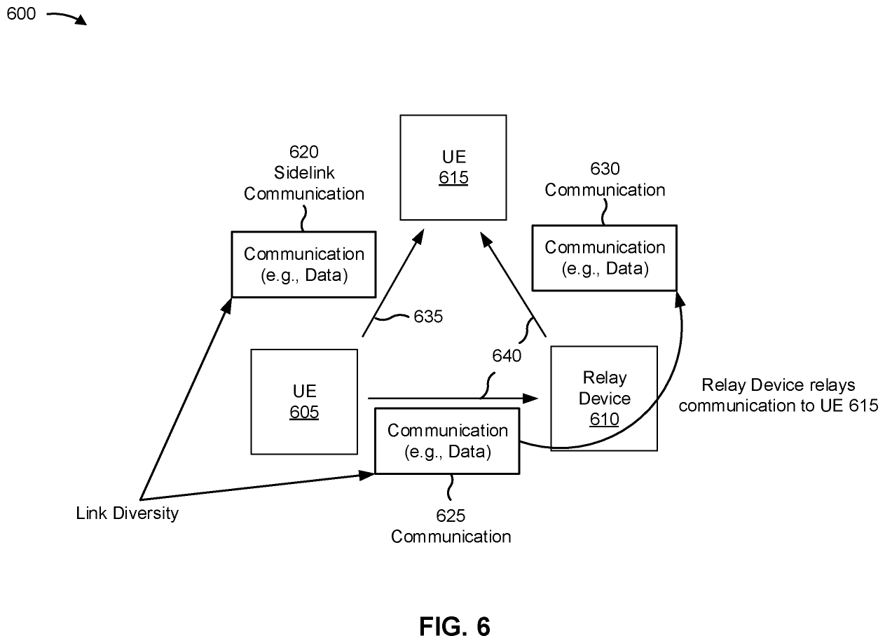

FIG. 6 is a diagram illustrating an example 600 of a relay device (e.g., a relay node) that relays communications between a first UE (e.g., a transmit node) and a second UE (e.g., a receive node), in accordance with the present disclosure. Although some aspects are described herein in terms of a “transmit node” and a “receive node,” the terms “transmit node” and “receive node” may be used as examples with regard to a particular communication. In other words, the “receive node” may transmit to the “transmit node” (or to any other device or network node), such as for configuring settings for the “transmit node” to transmit a subsequent communication to the “receive node.” Similarly, the “transmit node” may receive information from the “receive node” (or any from any other device or network node).

As shown, example 600 includes a UE 605, a relay device 610, and a UE 615. In example 600, the UE 605 is a Tx UE, and the UE 615 is an Rx UE. The relay device 610 may be an RIS (or modified RIS) or an AF node, among other examples. The UE 605 is one UE 120, and the UE 615 is another UE 120. The UE 605 may be referred to as a remote UE.

It is understood that an RIS differs from an AF node in various aspects. For example, an RIS operates by passive or active reflection, while an AF node operates by active reception and transmission. Since the AF node actively receives and transmits, the AF node is capable of amplifying or attenuating a received signal; however, the RIS typically merely reflects the incident signal. As described further below, the RIS can also attenuate, but does not generally amplify signals (although, in a modified RIS that includes some active RF chains within an array of passive elements described further below, amplification may be possible). Because of this, an RIS may not include analog-to-digital conversion (ADC) (and digital-to-analog conversion (DAC)), while an AF node typically does include analog-to-digital converters and/or digital-to-analog converters. This means that the hardware cost (and energy consumption) for an RIS can be lower than the hardware cost (and energy consumption) of an AF node.

An RIS is considered configurable and intelligent because it can allow control of the beam direction of the reflected signal, for example, directing the reflected signal towards the location of an intended Rx UE. One example of an RIS device can include a microstrip reflectarray made up of an array of elements, where each element includes a microstrip metal pattern. Each element in the array can be designed to scatter the incident field (signal) with a proper phase such that the array as a whole will reflect the field (signal) in a given direction. This phase can be understood to be a weight corresponding to each element in the array making up the RIS device. In one example, an element in the array can include one or more diodes (e.g., a varactor diodes) connecting the microstrip metal pattern to ground and/or one or more diodes connecting different isolated metal strips within the pattern to each other and/or to ground. The weight for each element can then be adjusted by adjusting the bias voltage of each diode within the element.

As shown in FIG. 6, the UE 605 may transmit a communication (e.g., data and/or control information) directly to the UE 615 as a sidelink communication 620. Additionally, or alternatively, the UE 605 may transmit a communication (e.g., data and/or control information) indirectly to the UE 615 via the relay device 610. For example, the UE 605 may transmit the communication to the relay device 610 as a communication 625, and the relay device 610 may relay (e.g., forward or transmit) the communication to the UE 615 as a communication 630.

The UE 605 may communicate directly with the UE 615 via a sidelink 635. For example, the sidelink communication 620 may be transmitted via the sidelink 635. A communication transmitted via the sidelink 635 between the UE 605 and the UE 615 (e.g., in the sidelink communication 620) does not pass through and is not relayed by the relay device 610. The UE 605 may communicate indirectly with the UE 615 via an indirect link 640. For example, the communication 625 and the communication 630 may be transmitted via different segments of the indirect link 640. A communication transmitted via the indirect link 640 between the UE 605 and the UE 615 (e.g., in the communication 625 and the communication 630) passes through and is relayed by the relay device 610.

Using the communication scheme shown in FIG. 6 may improve network performance and increase reliability by providing the UE 605 with link diversity for communicating with the UE 615. For millimeter wave (e.g., frequency range 2, or FR2) communications, which are susceptible to link blockage and link impairment, this link diversity improves reliability and prevents multiple retransmissions of data that may otherwise be retransmitted in order to achieve a successful communication. Similarly, for V2X communications, which may be associated with a limited spectrum for communications, this link diversity improves reliability and prevents multiple retransmissions of data that may otherwise be retransmitted in order to achieve a successful communication. However, techniques described herein are not limited to millimeter wave communications, and may be used for sub-6 gigahertz (e.g., frequency range 1, or FR1) communications.

In some cases, the UE 605 may transmit a communication (e.g., the same communication) to the UE 615 via both the sidelink 635 and the indirect link 640. In other cases, the UE 605 may select one of the links (e.g., either the sidelink 635 or the indirect link 640) and may transmit a communication to the UE 615 using only the selected link. Alternatively, the UE 605 may receive an indication of one of the links (e.g., either the sidelink 635 or the indirect link 640) and may transmit a communication to the UE 615 using only the indicated link. The indication may be transmitted by the UE 615 and/or the relay device 610. Such selection and/or indication may be based at least in part on channel conditions and/or link reliability.

In some cases, the UE 615 may receive communications from multiple UEs 605. For example, UE 615 may receive a first communication from a first UE 605 via relay device 610 on an indirect link and a second communication from a second UE 605 on a direct link. Alternatively, UE 615 may receive a first communication from a first UE 605 via a first relay device 610 on a first indirect link and a second communication from a second UE 605 via a second relay device 610 on a second indirect link.

As indicated above, FIG. 6 is provided as an example. Other examples may differ from what is described with respect to FIG. 6.

As described above, in a resource selection procedure, a UE may reserve shared resources and transmit on the shared resources to one or more other UEs. For example, a primary UE may reserve resources in a resource selection window and transmit, using the reserved resources, to a first remote UE and a second remote UE. Further, the primary UE may configure the first remote UE and/or the second remote UE to transmit on one or more resources of the resource selection window using a set of configured ports. Examples for communicating with multiple remote UEs may include using orthogonal resources or MU-MIMO communication to ensure separability of concurrent transmissions at a receiver (e.g., the primary UE).

With regard to MU-MIMO communication, the primary UE (or a base station) may schedule use of shared resources by remote UEs, indicate ports to use, and indicate co-scheduled ports for rate-matching and channel estimation. In some cases, a reservation of resources may include an indication of a DMRS pattern (e.g., a quantity of DMRSs, a type of DMRSs, a location of DMRS symbols, an index of code division multiplexing (CDM) groups, or an index of ports), ports available for co-scheduling (e.g., which may be based at least in part on a UE capability of an Rx UE with respect to nulling interfering communications). Nulling interfering communications may be performed by a Rx UE based at least in part on detecting SCI and deriving a PSSCH DMRS sequence from the SCI.

Power control may be important for concurrent communications, such as in MU-MIMO. For example, transmit nodes, which are transmitting concurrently to the same receive node, may exceed a configured transmit power, which may result in issues at the receive side. For example, when a first signal with a first power level is added to a second signal with a second power level at a receive node, an automatic gain control (AGC) capability and power control outer and inner loops may not apply the correct quantization and processing in a Fast Fourier Transform (FFT) block and/or other signal processing blocks. As a result, digital processing performance may be relatively poor.

When the two transmit nodes are communicating directly with the receive node, the receive node may configure transmit powers for both transmit nodes. However, when the receive node is communicating indirectly with one or more of the transmit nodes (e.g., a relay node is relaying communications between the receive node and a transmit node), a latency may exist between transmit power control commands to one or more of the transmit nodes (e.g., a latency associated with the relay node relating the transmit power control command), which may negatively impact an effectiveness of power control procedures. Moreover, altering a transmit power of the transmit node may result in issues with phase continuity of transmissions.

Some aspects described herein enable relay node aided MU-MIMO communication. For example, a receive node may transmit information to a relay node for a transmit node to cause the relay node to control an attenuation or amplification applied to a transmission from the transmit node by the relay node. In this case, by controlling the attenuation or the amplification applied by the relay node, the receive node may control a power of the transmission when the transmission is received by the receive node. For example, the receive node may balance a first power level of a first transmit node (e.g., by controlling an attenuation or amplification applied by a relay node for the first transmit node communicating on an indirect link) with a second power level of a second transmit node (e.g., by directly controlling the second transmit node communicating on a direct link). Alternatively, the receive node may balance a first power level of a first transmit node (e.g., by controlling an attenuation or amplification applied by a first relay node for the first transmit node communicating on a first indirect link) with a second power level of a second transmit node (e.g., by controlling an attenuation or amplification applied by a second relay node for the second transmit node communicating on a second indirect link). In this way, the receive node can control power levels of concurrent transmissions received at the receive node, thereby improving signal processing by the receive node. Moreover, by avoiding altering the transmit power of, for example, the first transmit node, the receive node enables the first transmit node to maintain phase continuity of transmissions, which improves communication performance.

FIGS. 7A and 7B are diagrams illustrating examples 700/700′ associated with relay node aided MU-MIMO communication, in accordance with the present disclosure. As shown in FIGS. 7A and 7B, examples 700/700′ includes communication between a receive node 705 and a set of transmit nodes 710-1 and 710-2 via one or more relay nodes 715 (e.g., a single relay node 715 in FIG. 7A and a first relay node 715-1 and a second relay node 715-2 in FIG. 7B). In some aspects, nodes 705-715 may correspond to UEs 120 (which may be UEs operating as relay nodes, RISs, fixed relay nodes, among other examples) and may be included in a wireless network, such as wireless network 100. Although some aspects are described in terms of a receive node 705 that is a UE 120, in another example, a receive node 705 may be a base station 110, which may provide a Uu link to transmit nodes 710 rather than a sidelink.

As further shown in FIG. 7A, and by reference number 750, receive node 705 may transmit a command to relay node 715. For example, receive node 705 may transmit an indication of a configured power to relay node 715 to cause relay node 715 to adjust an amplification or attenuation that is applied to transmissions that are relayed by relay node 715 from transmit node 710-1 to receive node 705. In the aforementioned case where receive node 705 is a base station 110, receive node 705 may use, for example DCI, RRC signaling, or medium access control (MAC) control element (CE) (MAC-CE) signaling to transmit the indication of the configured power. In another scenario with multiple transmit receive points (mTRPs), receive node 705 may transmit the indication of the configured power to adjust an mTRP received power (e.g., relay node 715) power rather than a transmit power of transmit node 710.

In some aspects, receive node 705 may transmit information identifying the configured power. For example, receive node 705 may identify the configured power with which receive node 705 is to receive transmissions from transmit node 710-1. In this case, relay node 715 may derive an amount of amplification or attenuation to apply to achieve the configured power. Additionally, or alternatively, receive node 705 may transmit an indication associated with identifying the configured power, such as an explicit indication of the amount of amplification or attenuation to apply to transmissions form transmit node 710-1. For example, receive node 705 may transmit information identifying a scaling factor that a controller of a RIS (relay node 715) is to apply to elements of the RIS such that a reflected power is reduced by a factor a to achieve the configured power Po at receive node 705. As noted above, an RIS can reflect in a given direction or beam based on a set of weights to apply to the elements within the RIS (where each element has a corresponding one or more weights within the set of weights). In order to achieve the scaling factor (whether determined by the RIS or received by the RIS from the receive node 705), each weight applied to the elements within the RIS may be multiplied by the scaling factor. As discussed above, it is understood that the one or more weights corresponding to each element in the RIS may be implemented by applying appropriate bias voltages to one or more diodes within each element in the RIS.

In some aspects, receive node 705 may determine the attenuation parameter a for relay node 715 based at least in part on a capability indicator. For example, receive node 705 may transmit a capability indicator (or a base station may provide stored information identifying the capability indicator) identifying a range of values for the attenuation parameter or a granularity with which the attenuation parameter can be changed, among other examples. In this case, for a quantity k different possible attenuation parameter values, receive node 705 may indicate an attenuation parameter using log₂(k) bits. Additionally, or alternatively, receive node 705 may have other constraints on the value of the attenuation parameter that enable receive node 705 to signal a value of the attenuation parameter using fewer bits. For example, rather than signal an absolute value of the attenuation parameter, receive node 705 may signal a change to a current value of the attenuation parameter, which may reduce a quantity of bits to signal an updated value for the attenuation parameter. Additionally, or alternatively, receive node 705 may indicate a maximum attenuation parameter, a minimum attenuation parameter, or a set of allowable attenuation parameters (e.g., a bitmap of allowed attenuation parameters within a range of possible attenuation parameters), among other examples. In some aspects, relay node 715 may identify the attenuation parameter based at least in part on an associated parameter. For example, when multiple relay nodes 715 are present, such as in FIG. 7B, each attenuation parameter may be based at least in part on a codebook and a capability indicator, which may enable distinguishing between different signaled attenuation parameters.

In some aspects, receive node 705 may configure the power to be received by receive node 705, P1, from transmit node 710-1 (e.g., by configuring attenuation or amplification by relay node 715), such that P1 is within a threshold difference Δ of a power to be received by receive node 705 from transmit node 710-2. For example, receive node 705 may configure the scaling factor and resulting a value such that αP1=P2+/−Δ. In other words, the scaled received signal power from transmit node 710-1 is within the threshold difference of the unscaled received signal power from transmit node 710-2. In some aspects, the size of the threshold difference may be based at least in part on an AGC or quantum observation capability of receive node 705 (e.g., a capability of receive node 705 to compensate for relatively small received signal power differences from transmit nodes 710-1 and 710-2). For clarity, the received signal power from a transmit node 710 may also be referred to as a transmit power from the transmit node 710. It is understood that a value for the received signal power at a receiver of a signal may differ from a value for a transmit power at a transmitter of the signal in accordance with attenuation, channel conditions, blocking, or beam alignment, among other examples.

In some aspects, relay node 715 may transmit a power command to transmit node 710-1 to cause an adjustment to a received signal power from transmit node 710-1. In other words, the power command may cause an adjustment to a transmit power, which may cause an adjustment to a corresponding received signal power. For example, when amplification is to occur to balance received signal powers of transmit nodes 710 and when passive MIMO (P-MIMO) is enabled, relay node 715 may not have an amplification capability (e.g., a capability of applying an a value greater than 1). In this case, relay node 715 may provide a power command, based at least in part on the received power command from receive node 705, to transmit node 710-1 to cause transmit node 710-1 to increase a received signal power. In this case, relay node 715 may forgo changing an amplification or attenuation configuration based at least in part on transmit node 710-1 performing the received signal power adjustment. Additionally, or alternatively, receive node 705 may turn off an MU-MIMO capability (e.g., by indicating an a value of 0), which may cause transmit node 710-1 to forgo using reserved resources or ports for transmission. In this case, receive node 705 may indicate to transmit node 710-2 (e.g., transmit node 710-2 may receive the indication to relay node 715 to turn off the MU-MIMO capability or receive node 705 may transmit dedicated signaling to transmit node 710-2) that the reserved resources or ports are available (e.g., not being used by transmit node 710-1). As a result, transmit node 710-2 may increase a received signal power, use additional resources, or use additional ports without interfering with transmissions from transmit node 710-1. Additionally, or alternatively, receive node 705 may transmit a command to transmit node 710-2 to reduce a power of transmit node 710-2, thereby obviating a need for transmit node 710-1 and/or relay node 715 to increase a received signal power.

Similarly, as shown in FIG. 7B, and by reference number 750′, receive node 705 may transmit respective indications of a configured received signal power to respective relay nodes 715. For example, receive node 705 may transmit a first power command to relay node 715-1 to adjust a first scaling parameter, α₁, of relay node 715-1 and transmit a second power command to relay node 715-2 to adjust a second scaling parameter, α₂, of relay node 715-2. In this case, receive node 705 may determine the power commands such that α₁P₁=α₂P₂+/−Δ. In some aspects, receive node 705 (or a base station associated therewith) may indicate a network architecture scenario to relay nodes 715. For example, receive node 705 may indicate, to relay node 715-1 and transmit node 710-1 whether transmit node 710-2 is communicating with receive node 705 via a relay node 715-2 (as in FIG. 7B) or directly (as in FIG. 7A). In this case, transmit node 710-1 and/or relay node 715-2 may set a transmit power (e.g., to set a corresponding received signal power), an attenuation, an amplification, or another parameter based at least in part on the network architecture scenario. Additionally, or alternatively, transmit node 710-2 may receive information indicating whether presence of relay node 715-2, which may cause transmit node 710-2 to attempt to receive direct power commands (when no relay node 715-2 is present) or forgo attempting to receive direct power commands (when relay node 715-2 is present and can perform attenuation or amplification on behalf of transmit node 710-2).

As further shown in FIGS. 7A and 7B, and by reference number 755, transmit nodes 710 may transmit one or more communications to receive node 705. For example, transmit node 710-1 may transmit a communication to relay node 715/715-1, which may amplify or attenuate the communication and relay the communication to receive node 705. Similarly, transmit node 710-2 may transmit a communication directly to receive node 705 (as shown in FIG. 7A) or indirectly via relay node 715-2 (as shown in FIG. 7B), which may amplify or attenuate the communication. In this case, receive node 705 may receive the respective communications from transmit nodes 710 and process the respective communications.

As indicated above, FIGS. 7A and 7B are provided as examples. Other examples may differ from what is described with respect to FIGS. 7A and 7B.

FIG. 8 is a diagram illustrating an example process 800 performed, for example, by a relay node, in accordance with the present disclosure. Example process 800 is an example where the relay node (e.g., UE 120 or relay nodes 715/715-1/715-2) performs operations associated with relay node aided MU-MIMO communication.

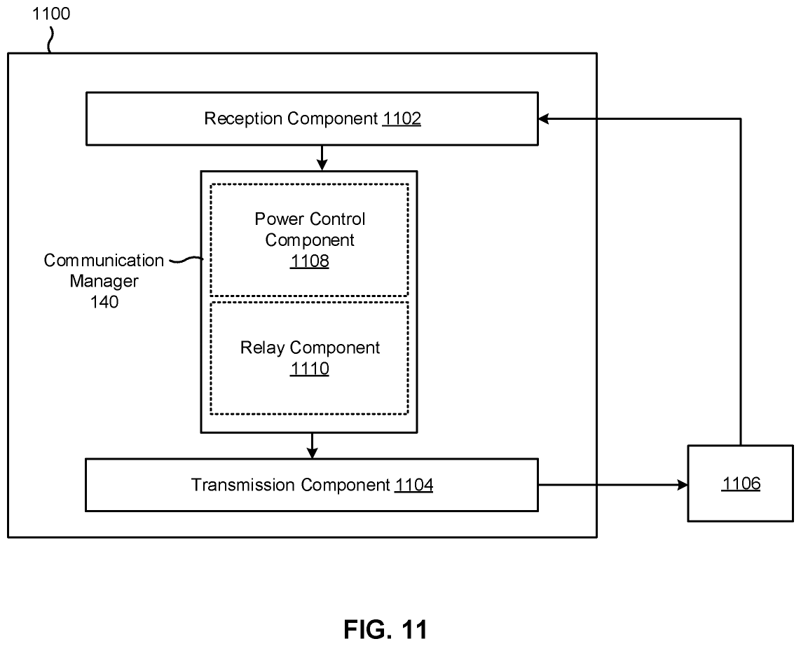

As shown in FIG. 8, in some aspects, process 800 may include receiving information associated with identifying a configured power level of a communication at a receive node (block 810). For example, the relay node (e.g., using communication manager 140 and/or reception component 1102, depicted in FIG. 11) may receive information associated with identifying a configured power level of a communication at a receive node, as described above with reference to FIGS. 7A and 7B.

As further shown in FIG. 8, in some aspects, process 800 may include relaying the communication from a transmit node to the receive node in accordance with the configured power level, wherein relaying the communication includes attenuating or amplifying the communication based at least in part on the configured power level (block 820). For example, the relay node (e.g., using communication manager 140 and/or relay component 1110, depicted in FIG. 11) may relay the communication from a transmit node to the receive node in accordance with the configured power level, wherein relaying the communication includes attenuating or amplifying the communication based at least in part on the configured power level, as described above with reference to FIGS. 7A and 7B. It is understood that, in some implementations, the relay node relaying the communication may include the relay node reflecting a signal associated with the communication while attenuating or amplifying as discussed above.

Process 800 may include additional aspects, such as any single aspect or any combination of aspects described below and/or in connection with one or more other processes described elsewhere herein.

In a first aspect, the information associated with identifying the configured power level includes an indication of a scaling factor for attenuating or amplifying the communication.

In a second aspect, alone or in combination with the first aspect, the configured power level of the communication from the transmit node is based at least in part on a power level of an other communication from an other transmit node.

In a third aspect, alone or in combination with one or more of the first and second aspects, process 800 includes attenuating or amplifying a power level of the communication to within a threshold difference of the power level of the other communication from the other transmit node.

In a fourth aspect, alone or in combination with one or more of the first through third aspects, process 800 includes providing the information associated with identifying the configured power level to the transmit node to cause an adjustment to a transmit power of the communication by the transmit node.

In a fifth aspect, alone or in combination with one or more of the first through fourth aspects, process 800 includes providing a command to cause an adjustment to a MU-MIMO configuration by the transmit node, and adjusting a scaling factor based at least in part on causing the adjustment to the MU-MIMO configuration.

In a sixth aspect, alone or in combination with one or more of the first through fifth aspects, a first scaling parameter of the relay node is based at least in part on a second scaling parameter of an other relay node associated with an other transmit node in communication with the receive node.

In a seventh aspect, alone or in combination with one or more of the first through sixth aspects, process 800 includes transmitting, to the receive node, information identifying a configuration of one or more attenuation parameters, and wherein the information associated with identifying the configured power level is based at least in part on the information identifying the configuration of the one or more attenuation parameters.

In an eighth aspect, alone or in combination with one or more of the first through seventh aspects, the information associated with identifying the configured power level includes information identifying at least one of a scaling factor value, a range of scaling factor values, a maximum amount of attenuation or amplification, a minimum amount of attenuation or amplification, a set of allowed scaling factor values, or a combination thereof.

In a ninth aspect, alone or in combination with one or more of the first through eighth aspects, process 800 includes providing, to the transmit node, received information indicating a network architecture scenario, wherein a transmit power of the transmit node for the communication is based at least in part on the network architecture scenario.

In a tenth aspect, alone or in combination with one or more of the first through ninth aspects, the receive node is a UE communicating on a sidelink or a base station communicating on an access link.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a receive node, in accordance with the present disclosure. Example process 900 is an example where the receive node (e.g., UE 120 or receive node 705) performs operations associated with relay node aided MU-MIMO communication.

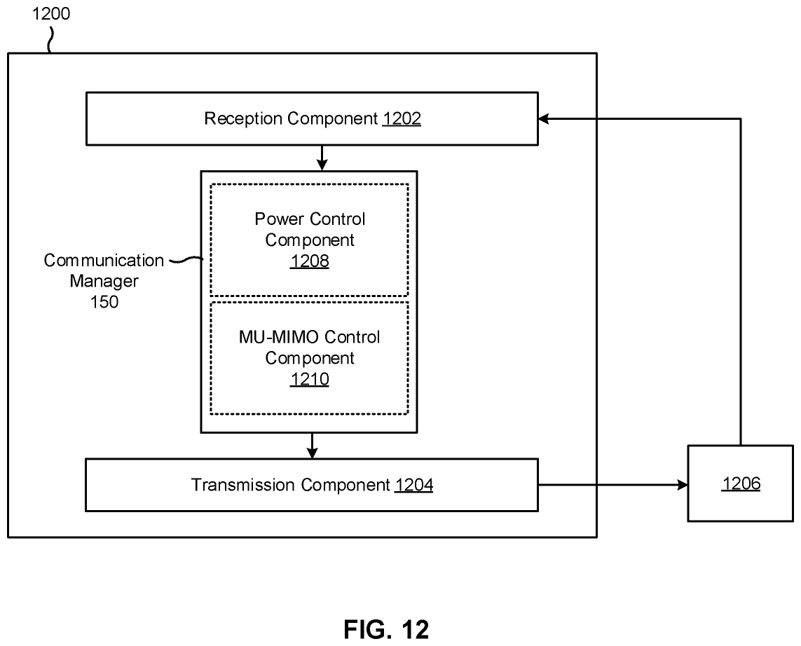

As shown in FIG. 9, in some aspects, process 900 may include transmitting, to a relay node associated with relaying communications for a first transmit node, information associated with identifying a configured power level at a receive node, wherein the configured power level is based at least in part on a first configuration of the first transmit node and a second configuration of a second transmit node in communication with the receive node (block 910). For example, the receive node (e.g., using communication manager 150 and/or transmission component 1204, depicted in FIG. 12) may transmit, to a relay node associated with relaying communications for a first transmit node, information associated with identifying a configured power level at a receive node, wherein the configured power level is based at least in part on a first configuration of the first transmit node and a second configuration of a second transmit node in communication with the receive node, as described above with reference to FIGS. 7A and 7B.

As further shown in FIG. 9, in some aspects, process 900 may include receiving one or more communications from at least one of the first transmit node, via the relay node, or the second transmit node in accordance with the configured power level, wherein the relay node is configured for attenuating or amplifying a communication, of the one or more communications, based at least in part on the configured power level (block 920). For example, the receive node (e.g., using communication manager 150 and/or reception component 1202, depicted in FIG. 12) may receive one or more communications from at least one of the first transmit node, via the relay node, or the second transmit node in accordance with the configured power level, wherein the relay node is configured for attenuating or amplifying a communication, of the one or more communications, based at least in part on the configured power level, as described above with reference to FIGS. 7A and 7B.

Process 900 may include additional aspects, such as any single aspect or any combination of aspects described below and/or in connection with one or more other processes described elsewhere herein.

In a first aspect, the information associated with identifying the configured power level includes an indication of a scaling factor for the relay node for attenuating or amplifying the communication.

In a second aspect, alone or in combination with the first aspect, the configured power level for the first transmit node is based at least in part on an other configured power level of the second transmit node.

In a third aspect, alone or in combination with one or more of the first and second aspects, the relay node is configured to attenuate or amplify a power level of the communication to within a threshold delta value of the other configured power level of the second transmit node.

In a fourth aspect, alone or in combination with one or more of the first through third aspects, process 900 includes providing the information associated with identifying the configured power level to the first transmit node to cause an adjustment to a transmit power of the communication by the first transmit node.

In a fifth aspect, alone or in combination with one or more of the first through fourth aspects, process 900 includes providing a command to cause an adjustment to a MU-MIMO configuration by the first transmit node and to cause an adjustment to a scaling factor of the relay node.

In a sixth aspect, alone or in combination with one or more of the first through fifth aspects, process 900 includes providing a first command to the first transmit node to turn off a MU-MIMO communication mode, and providing a second command to the second transmit node to transmit using resources vacated by the first transmit node turning off the MU-MIMO communication mode.

In a seventh aspect, alone or in combination with one or more of the first through sixth aspects, the relay node is a first relay node and the second transmit node is configured to communicate with the receive node via a second relay node, and further comprising providing information to the second relay node to control attenuation or amplification for the second transmit node.

In an eighth aspect, alone or in combination with one or more of the first through seventh aspects, a first scaling parameter of the first relay node is based at least in part on a second scaling parameter of the second relay node.

In a ninth aspect, alone or in combination with one or more of the first through eighth aspects, process 900 includes receiving, from the relay node, information identifying a configuration of one or more attenuation parameters, and wherein the information associated with identifying the configured power level is based at least in part on the information identifying the configuration of the one or more attenuation parameters.

In a tenth aspect, alone or in combination with one or more of the first through ninth aspects, the information associated with identifying the configured power level includes information identifying at least one of a scaling factor value, a range of scaling factor values, a maximum amount of attenuation or amplification, a minimum amount of attenuation or amplification, a set of allowed scaling factor values, or a combination thereof.

In an eleventh aspect, alone or in combination with one or more of the first through tenth aspects, process 900 includes providing information indicating a network architecture scenario, wherein a transmit power of the first transmit node or the second transmit node for the communication is based at least in part on the network architecture scenario.

In a twelfth aspect, alone or in combination with one or more of the first through eleventh aspects, the receive node is a UE communicating on a sidelink or a base station communicating on an access link.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a transmit node, in accordance with the present disclosure. Example process 1000 is an example where the transmit node (e.g., UE 120 or transmit nodes 710-1/710-2) performs operations associated with relay node aided MU-MIMO communication.

As shown in FIG. 10, in some aspects, process 1000 may include receiving, from a relay node, information associated with identifying a configured power level of a communication at a receive node (block 1010). For example, the transmit node (e.g., using communication manager 150 and/or reception component 1202, depicted in FIG. 12) may receive, from a relay node, information associated with identifying a configured power level of a communication at a receive node, as described above with reference to FIGS. 7A and 7B.

As further shown in FIG. 10, in some aspects, process 1000 may include transmitting the communication to the receive node in accordance with the configured power level and via a relay node, wherein the communication is attenuated or amplified based at least in part on the configured power level (block 1020). For example, the transmit node (e.g., using communication manager 150 and/or transmission component 1204, depicted in FIG. 12) may transmit the communication to the receive node in accordance with the configured power level and via a relay node, wherein the communication is attenuated or amplified based at least in part on the configured power level, as described above with reference to FIGS. 7A and 7B.

Process 1000 may include additional aspects, such as any single aspect or any combination of aspects described below and/or in connection with one or more other processes described elsewhere herein.

In a first aspect, the information associated with identifying the configured power level includes an indication of a scaling factor for attenuating or amplifying the communication.

In a second aspect, alone or in combination with the first aspect, the configured power level of the communication at transmission is based at least in part on a power level of an other communication from an other transmit node.

In a third aspect, alone or in combination with one or more of the first and second aspects, the communication is attenuated or amplified to a power level within a threshold difference of the power level of the other communication from the other transmit node.

In a fourth aspect, alone or in combination with one or more of the first through third aspects, process 1000 includes adjusting a transmit power of the communication based at least in part on the configured power level.

In a fifth aspect, alone or in combination with one or more of the first through fourth aspects, process 1000 includes adjusting a MU-MIMO configuration based at least in part on the configured power level, wherein a scaling factor of the relay node is adjusted based at least in part on the adjustment to the MU-MIMO configuration.

In a sixth aspect, alone or in combination with one or more of the first through fifth aspects, the information associated with identifying the configured power level includes information identifying at least one of a scaling factor value, a range of scaling factor values, a maximum amount of attenuation or amplification, a minimum amount of attenuation or amplification, a set of allowed scaling factor values, or a combination thereof.

In a seventh aspect, alone or in combination with one or more of the first through sixth aspects, process 1000 includes receiving information indicating a network architecture scenario, and adjusting a transmit power of the transmit node for the communication based at least in part on the network architecture scenario.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a relay node (e.g., a UE), or a relay node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a power control component 1108 or a relay component 1110, among other examples.

In some aspects, the apparatus 1100 may be configured to perform one or more operations described herein in connection with FIGS. 7A-7B. Additionally, or alternatively, the apparatus 1100 may be configured to perform one or more processes described herein, such as process 800 of FIG. 8. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive information associated with identifying a configured power level of a communication at a receive node. The relay component 1110 may relay the communication from a transmit node to the receive node in accordance with the configured power level, wherein relaying the communication includes attenuating or amplifying the communication based at least in part on the configured power level.

The power control component 1108 may attenuate or amplifying a power level of the communication to within a threshold difference of the power level of the other communication from the other transmit node. The transmission component 1104 may provide the information associated with identifying the configured power level to the transmit node to cause an adjustment to a transmit power of the communication by the transmit node. The transmission component 1104 may provide a command to cause an adjustment to a MU-MIMO configuration by the transmit node.

The power control component 1108 may adjust a scaling factor based at least in part on causing the adjustment to the MU-MIMO configuration. The transmission component 1104 may transmit, to the receive node, information identifying a configuration of one or more attenuation parameters wherein the information associated with identifying the configured power level is based at least in part on the information identifying the configuration of the one or more attenuation parameters. The transmission component 1104 may provide, to the transmit node, received information indicating a network architecture scenario, wherein a transmit power of the transmit node for the communication is based at least in part on the network architecture scenario.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a receive node or transmit node (e.g., a UE or a base station), or a receive node or transmit node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include one or more of a power control component 1208 or an MU-MIMO control component 1210, among other examples.

In some aspects, the apparatus 1200 may be configured to perform one or more operations described herein in connection with FIGS. 7A-7B. Additionally, or alternatively, the apparatus 1200 may be configured to perform one or more processes described herein, such as process 900 of FIG. 9, process 1000 of FIG. 10, or a combination thereof. In some aspects, the apparatus 1200 and/or one or more components shown in FIG. 12 may include one or more components of the relay node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the relay node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the relay node described in connection with FIG. 2. In some aspects, the transmission component 1204 may be co-located with the reception component 1202 in a transceiver.

The transmission component 1204 may transmit, to a relay node associated with relaying communications for a first transmit node, information associated with identifying a configured power level at a receive node, wherein the configured power level is based at least in part on a first configuration of the first transmit node and a second configuration of a second transmit node in communication with the receive node. The reception component 1202 may receive one or more communications from at least one of the first transmit node, via the relay node, or the second transmit node in accordance with the configured power level, wherein the relay node is configured for attenuating or amplifying a communication, of the one or more communications, based at least in part on the configured power level.

The transmission component 1204 may provide the information associated with identifying the configured power level to the first transmit node to cause an adjustment to a transmit power of the communication by the first transmit node. The transmission component 1204 may provide a command to cause an adjustment to a MU-MIMO configuration by the first transmit node and to cause an adjustment to a scaling factor of the relay node. The transmission component 1204 may provide a first command to the first transmit node to turn off a MU-MIMO communication mode. The transmission component 1204 may provide a second command to the second transmit node to transmit using resources vacated by the first transmit node turning off the MU-MIMO communication mode. The reception component 1202 may receive, from the relay node, information identifying a configuration of one or more attenuation parameters wherein the information associated with identifying the configured power level is based at least in part on the information identifying the configuration of the one or more attenuation parameters. The transmission component 1204 may provide information indicating a network architecture scenario, wherein a transmit power of the first transmit node or the second transmit node for the communication is based at least in part on the network architecture scenario.

The reception component 1202 may receive, from a relay node, information associated with identifying a configured power level of a communication at a receive node. The transmission component 1204 may transmit the communication to the receive node in accordance with the configured power level and via a relay node, wherein the communication is attenuated or amplified based at least in part on the configured power level. The power control component 1208 may adjust a transmit power of the communication based at least in part on the configured power level. The MU-MIMO control component 1210 may adjust a MU-MIMO configuration based at least in part on the configured power level, wherein a scaling factor of the relay node is adjusted based at least in part on the adjustment to the MU-MIMO configuration. The reception component 1202 may receive information indicating a network architecture scenario. The power control component 1208 may adjust a transmit power of the transmit node for the communication based at least in part on the network architecture scenario.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a relay node, comprising: receiving information associated with identifying a configured power level of a communication at a receive node; and relaying the communication from a transmit node to the receive node in accordance with the configured power level, wherein relaying the communication includes attenuating or amplifying the communication based at least in part on the configured power level.
Aspect 2: The method of Aspect 1, wherein the information associated with identifying the configured power level includes an indication of a scaling factor for attenuating or amplifying the communication.
Aspect 3: The method of any of Aspects 1 to 2, wherein the configured power level of the communication from the transmit node is based at least in part on a power level of an other communication from an other transmit node.
Aspect 4: The method of Aspect 3, further comprising: attenuating or amplifying a power level of the communication to within a threshold difference of the power level of the other communication from the other transmit node.
Aspect 5: The method of any of Aspects 1 to 4, further comprising: providing the information associated with identifying the configured power level to the transmit node to cause an adjustment to a transmit power of the communication by the transmit node.
Aspect 6: The method of any of Aspects 1 to 5, further comprising: providing a command to cause an adjustment to a multiple-user multiple-input multiple-output (MU-MIMO) configuration by the transmit node; and adjusting a scaling factor based at least in part on causing the adjustment to the MU-MIMO configuration.
Aspect 7: The method of any of Aspects 1 to 6, wherein a first scaling parameter of the relay node is based at least in part on a second scaling parameter of an other relay node associated with an other transmit node in communication with the receive node.
Aspect 8: The method of any of Aspects 1 to 7, further comprising: transmitting, to the receive node, information identifying a configuration of one or more attenuation parameters, and wherein the information associated with identifying the configured power level is based at least in part on the information identifying the configuration of the one or more attenuation parameters.
Aspect 9: The method of any of Aspects 1 to 8, wherein the information associated with identifying the configured power level includes information identifying at least one of: a scaling factor value, a range of scaling factor values, a maximum amount of attenuation or amplification, a minimum amount of attenuation or amplification, a set of allowed scaling factor values, or a combination thereof.
Aspect 10: The method of any of Aspects 1 to 9, further comprising: providing, to the transmit node, received information indicating a network architecture scenario, wherein a transmit power of the transmit node for the communication is based at least in part on the network architecture scenario.
Aspect 11: The method of any of Aspects 1 to 10, wherein the receive node is a user equipment (UE) communicating on a sidelink or a base station communicating on an access link.
Aspect 12: A method of wireless communication performed by a receive node, comprising: transmitting, to a relay node associated with relaying communications for a first transmit node, information associated with identifying a configured power level at a receive node, wherein the configured power level is based at least in part on a first configuration of the first transmit node and a second configuration of a second transmit node in communication with the receive node; and receiving one or more communications from at least one of the first transmit node, via the relay node, or the second transmit node in accordance with the configured power level, wherein the relay node is configured for attenuating or amplifying a communication, of the one or more communications, based at least in part on the configured power level.
Aspect 13: The method of Aspect 12, wherein the information associated with identifying the configured power level includes an indication of a scaling factor for the relay node for attenuating or amplifying the communication.
Aspect 14: The method of any of Aspects 12 to 13, wherein the configured power level for the first transmit node is based at least in part on an other configured power level of the second transmit node.
Aspect 15: The method of Aspect 14, wherein the relay node is configured to attenuate or amplify a power level of the communication to within a threshold delta value of the other configured power level of the second transmit node.
Aspect 16: The method of any of Aspects 12 to 15, further comprising: providing the information associated with identifying the configured power level to the first transmit node to cause an adjustment to a transmit power of the communication by the first transmit node.
Aspect 17: The method of any of Aspects 12 to 16, further comprising: providing a command to cause an adjustment to a multiple-user multiple-input multiple-output (MU-MIMO) configuration by the first transmit node and to cause an adjustment to a scaling factor of the relay node.
Aspect 18: The method of any of Aspects 12 to 17, further comprising: providing a first command to the first transmit node to turn off a multiple-user multiple-input multiple-output (MU-MIMO) communication mode; and providing a second command to the second transmit node to transmit using resources vacated by the first transmit node turning off the MU-MIMO communication mode.
Aspect 19: The method of any of Aspects 12 to 18, wherein the relay node is a first relay node and the second transmit node is configured to communicate with the receive node via a second relay node, and further comprising: providing information to the second relay node to control attenuation or amplification for the second transmit node.
Aspect 20: The method of Aspect 19, wherein a first scaling parameter of the first relay node is based at least in part on a second scaling parameter of the second relay node.
Aspect 21: The method of any of Aspects 12 to 20, further comprising: receiving, from the relay node, information identifying a configuration of one or more attenuation parameters, and wherein the information associated with identifying the configured power level is based at least in part on the information identifying the configuration of the one or more attenuation parameters.
Aspect 22: The method of any of Aspects 12 to 21, wherein the information associated with identifying the configured power level includes information identifying at least one of: a scaling factor value, a range of scaling factor values, a maximum amount of attenuation or amplification, a minimum amount of attenuation or amplification, a set of allowed scaling factor values, or a combination thereof.
Aspect 23: The method of any of Aspects 12 to 22, further comprising: providing information indicating a network architecture scenario, wherein a transmit power of the first transmit node or the second transmit node for the communication is based at least in part on the network architecture scenario.
Aspect 24: The method of any of Aspects 12 to 23, wherein the receive node is a user equipment (UE) communicating on a sidelink or a base station communicating on an access link.
Aspect 25: A method of wireless communication performed by a transmit node, comprising: receiving, from a relay node, information associated with identifying a configured power level of a communication at a receive node; and transmitting the communication to the receive node in accordance with the configured power level and via a relay node, wherein the communication is attenuated or amplified based at least in part on the configured power level.
Aspect 26: The method of Aspect 25, wherein the information associated with identifying the configured power level includes an indication of a scaling factor for attenuating or amplifying the communication.
Aspect 27: The method of any of Aspects 25 to 26, wherein the configured power level of the communication at transmission is based at least in part on a power level of an other communication from an other transmit node.
Aspect 28: The method of Aspect 27, wherein the communication is attenuated or amplified to a power level within a threshold difference of the power level of the other communication from the other transmit node.
Aspect 29: The method of any of Aspects 25 to 28, further comprising: adjusting a transmit power of the communication based at least in part on the configured power level.
Aspect 30: The method of any of Aspects 25 to 29, further comprising: adjusting a multiple-user multiple-input multiple-output (MU-MIMO) configuration based at least in part on the configured power level, wherein a scaling factor of the relay node is adjusted based at least in part on the adjustment to the MU-MIMO configuration.
Aspect 31: The method of any of Aspects 25 to 30, wherein the information associated with identifying the configured power level includes information identifying at least one of: a scaling factor value, a range of scaling factor values, a maximum amount of attenuation or amplification, a minimum amount of attenuation or amplification, a set of allowed scaling factor values, or a combination thereof.
Aspect 32: The method of any of Aspects 25 to 31, further comprising: receiving information indicating a network architecture scenario; and adjusting a transmit power of the transmit node for the communication based at least in part on the network architecture scenario.
Aspect 33: An apparatus for wireless communication at a device, comprising a processor; memory coupled with the processor; and instructions stored in the memory and executable by the processor to cause the apparatus to perform the method of one or more of Aspects 1-11.
Aspect 34: A device for wireless communication, comprising a memory and one or more processors coupled to the memory, the one or more processors configured to perform the method of one or more of Aspects 1-11.
Aspect 35: An apparatus for wireless communication, comprising at least one means for performing the method of one or more of Aspects 1-11.
Aspect 36: A non-transitory computer-readable medium storing code for wireless communication, the code comprising instructions executable by a processor to perform the method of one or more of Aspects 1-11.
Aspect 37: A non-transitory computer-readable medium storing a set of instructions for wireless communication, the set of instructions comprising one or more instructions that, when executed by one or more processors of a device, cause the device to perform the method of one or more of Aspects 1-11.
Aspect 38: An apparatus for wireless communication at a device, comprising a processor; memory coupled with the processor; and instructions stored in the memory and executable by the processor to cause the apparatus to perform the method of one or more of Aspects 12-24.
Aspect 39: A device for wireless communication, comprising a memory and one or more processors coupled to the memory, the one or more processors configured to perform the method of one or more of Aspects 12-24.
Aspect 40: An apparatus for wireless communication, comprising at least one means for performing the method of one or more of Aspects 12-24.
Aspect 41: A non-transitory computer-readable medium storing code for wireless communication, the code comprising instructions executable by a processor to perform the method of one or more of Aspects 12-24.
Aspect 42: A non-transitory computer-readable medium storing a set of instructions for wireless communication, the set of instructions comprising one or more instructions that, when executed by one or more processors of a device, cause the device to perform the method of one or more of Aspects 12-24.
Aspect 43: An apparatus for wireless communication at a device, comprising a processor; memory coupled with the processor; and instructions stored in the memory and executable by the processor to cause the apparatus to perform the method of one or more of Aspects 25-32.
Aspect 44: A device for wireless communication, comprising a memory and one or more processors coupled to the memory, the one or more processors configured to perform the method of one or more of Aspects 25-32.
Aspect 45: An apparatus for wireless communication, comprising at least one means for performing the method of one or more of Aspects 25-32.
Aspect 46: A non-transitory computer-readable medium storing code for wireless communication, the code comprising instructions executable by a processor to perform the method of one or more of Aspects 25-32.
Aspect 47: A non-transitory computer-readable medium storing a set of instructions for wireless communication, the set of instructions comprising one or more instructions that, when executed by one or more processors of a device, cause the device to perform the method of one or more of Aspects 25-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A relay node for wireless communication, comprising:
a memory; and
one or more processors, coupled to the memory, configured to:
receive information associated with identifying a configured power level of a communication at a receive node; and
relay the communication from a transmit node to the receive node in accordance with the configured power level, wherein relaying the communication includes attenuating or amplifying the communication based at least in part on the configured power level.

2. The relay node of claim 1, wherein the information associated with identifying the configured power level includes an indication of a scaling factor for attenuating or amplifying the communication.

3. The relay node of claim 1, wherein the configured power level of the communication from the transmit node is based at least in part on a power level of an other communication from an other transmit node.

4. The relay node of claim 3, wherein the one or more processors are further configured to:
attenuate or amplify a power level of the communication to within a threshold difference of the power level of the other communication from the other transmit node.

5. The relay node of claim 1, wherein the one or more processors are further configured to:
provide the information associated with identifying the configured power level to the transmit node to cause an adjustment to a transmit power of the communication by the transmit node.

6. The relay node of claim 1, wherein the one or more processors are further configured to:
provide a command to cause an adjustment to a multiple-user multiple-input multiple-output (MU-MIMO) configuration by the transmit node; and
adjust a scaling factor based at least in part on causing the adjustment to the MU-MIMO configuration.

7. The relay node of claim 1, wherein a first scaling parameter of the relay node is based at least in part on a second scaling parameter of an other relay node associated with an other transmit node in communication with the receive node.

8. The relay node of claim 1, wherein the one or more processors are further configured to:
transmit, to the receive node, information identifying a configuration of one or more attenuation parameters, and
wherein the information associated with identifying the configured power level is based at least in part on the information identifying the configuration of the one or more attenuation parameters.

9-11. (canceled)

12. A receive node for wireless communication, comprising:
a memory; and
one or more processors, coupled to the memory, configured to:
transmit, to a relay node associated with relaying communications for a first transmit node, information associated with identifying a configured power level at a receive node, wherein the configured power level is based at least in part on a first configuration of the first transmit node and a second configuration of a second transmit node in communication with the receive node; and
receive one or more communications from at least one of the first transmit node, via the relay node, or the second transmit node in accordance with the configured power level, wherein the relay node is configured for attenuating or amplifying a communication, of the one or more communications, based at least in part on the configured power level.

13. The receive node of claim 12, wherein the information associated with identifying the configured power level includes an indication of a scaling factor for the relay node for attenuating or amplifying the communication.

14. The receive node of claim 12, wherein the configured power level for the first transmit node is based at least in part on an other configured power level of the second transmit node.

15. The receive node of claim 14, wherein the relay node is configured to attenuate or amplify a power level of the communication to within a threshold delta value of the other configured power level of the second transmit node.

16. The receive node of claim 12, wherein the one or more processors are further configured to:
provide the information associated with identifying the configured power level to the first transmit node to cause an adjustment to a transmit power of the communication by the first transmit node.

17. The receive node of claim 12, wherein the one or more processors are further configured to:
provide a command to cause an adjustment to a multiple-user multiple-input multiple-output (MU-MIMO) configuration by the first transmit node and to cause an adjustment to a scaling factor of the relay node.

18-24. (canceled)

25. A transmit node for wireless communication, comprising:
a memory; and
one or more processors, coupled to the memory, configured to:
receive, from a relay node, information associated with identifying a configured power level of a communication at a receive node; and
transmit the communication to the receive node in accordance with the configured power level and via a relay node, wherein the communication is attenuated or amplified based at least in part on the configured power level.

26. The transmit node of claim 25, wherein the information associated with identifying the configured power level includes an indication of a scaling factor for attenuating or amplifying the communication.

27. The transmit node of claim 25, wherein the configured power level of the communication at transmission is based at least in part on a power level of an other communication from an other transmit node.

28. The transmit node of claim 27, wherein the communication is attenuated or amplified to a power level within a threshold difference of the power level of the other communication from the other transmit node.

29. The transmit node of claim 25, wherein the one or more processors are further configured to:
adjust a transmit power of the communication based at least in part on the configured power level.

30. The transmit node of claim 25, wherein the one or more processors are further configured to:
adjust a multiple-user multiple-input multiple-output (MU-MIMO) configuration based at least in part on the configured power level, wherein a scaling factor of the relay node is adjusted based at least in part on the adjustment to the MU-MIMO configuration.

31-35. (canceled)
